(19) United States
(12) Patent Application Publication
(10) Pub. No.: US 2023/0147767 A1
(43) Pub. Date: May 11, 2023

(54) STATE DETECTION SYSTEM

(71) Applicant: Konica Minolta, Inc., Tokyo (JP)

(72) Inventors: SABUROU HIRAOKA, Kodaira-shi, Tokyo (JP); IPPEI ENOKIDA, Suginami-ku, Tokyo (JP)

(21) Appl. No.: 17/918,813

(22) PCT Filed: Apr. 2, 2021
(86) PCT No.: PCT/JP2021/014259

§ 371 Date: Oct. 13, 2022

(30) Foreign Application Priority Data
Apr. 24, 2020 (JP) 2020-077776

(51) Int. Cl. G01N 21/55; G01N 22/04

(52) U.S. Cl. CPC G01N 21/55; G01N 22/04; G01N 2201/126

(57) ABSTRACT

A state detection system includes a sensor (10) that includes an electromagnetic wave reflecting material (13) and a resonator (11) disposed adjacent to or integrally with the electromagnetic wave reflecting material (13), and that detects a state change of a surrounding object or surrounding environment as a change in its own electromagnetic wave reflection characteristic, a reader (20) that transmits an electromagnetic wave to the sensor (10), that receives a reflected wave of the electromagnetic wave, and that acquires reflected wave spectrum information of the sensor (10), and an analysis device (30) that estimates a current state of a detection target of the sensor (10) by applying information regarding reflected wave intensities at a plurality of frequency positions of the reflected wave spectrum to a learning model (30D) generated in advance on a basis of training data of a reflected wave spectrum for each state of the sensor (10).

### TECHNICAL FIELD

The present disclosure relates to a state detection system.

### BACKGROUND ART

A state detection system that detects a state change of an object or an environment using an electromagnetic wave is known.

This type of state detection system generally includes a sensor that includes a resonator and a reader that transmits and receives electromagnetic waves. In this type of state detection system, a method is used in which the reader detects a state change of the sensor by receiving a reflected wave from the sensor when the reader transmits an electromagnetic wave of a predetermined frequency to the sensor.

Since this type of state detection system can detect a state of an object in a non-contact manner, application to various uses such as article management is expected.

From such a background, for example, Patent Literature 1 discloses a state detection system in which an LC resonance tag is attached to a diaper or a urine absorbing pad, and in which a state change (dirt) of the object is detected from a change in the resonance frequency of the LC resonance tag due to absorption of a discharge by the diaper or the urine absorbing pad. At this time, Patent Literature 1 employs a method of periodically identifying the resonance frequency of the LC resonance tag to capture a change in the resonance frequency of the LC resonance tag, thereby detecting a state change (dirt) of the object (also referred to as a peak pick method).

### CITATION LIST

### Patent Literature

Patent Literature 1: JP 2001-134726 A

### SUMMARY OF INVENTION

### Technical Problem

Meanwhile, in this type of state detection system, generally, there is a problem in which it is difficult to secure the intensity of the reflected wave from the sensor and in which it is difficult to secure a good SN ratio. Therefore, a reflected wave spectrum of the sensor to be acquired (the spectrum hereinbelow represents a frequency spectrum of the reflected wave) is a spectrum on which many noises are superimposed, and it is often difficult to clearly identify the resonance frequency of the sensor.

Hence, a method (peak pick method) of detecting a state change (moisture content of the urine absorbing pad) of the detection target by identifying a change in the resonance frequency of the LC resonance tag before and after the change in the moisture amount around the LC resonance tag as in the state detection system in Patent Literature 1 has a problem in which erroneous detection caused by noise is likely to occur. In other words, with such a method, it is difficult to detect the state with high accuracy.

The present disclosure has been made in view of such problems, and an object thereof is to provide a state detection system capable of detecting a state change of an object or an environment with high accuracy.

### Solution to Problem

The present main disclosure for solving the aforementioned problems relates to a state detection system including a sensor that includes an electromagnetic wave reflecting material and a resonator disposed adjacent to or integrally with the electromagnetic wave reflecting material, and that detects a state change of a surrounding object or surrounding environment as a change in its own electromagnetic wave reflection characteristic, a reader that transmits an electromagnetic wave to the sensor and receives a reflected wave of the electromagnetic wave, and that acquires reflected wave spectrum information of the sensor, and an analysis device that estimates a current state of a detection target of the sensor by applying information regarding reflected wave intensities at a plurality of frequency positions of the reflected wave spectrum to a learning model generated in advance on a basis of training data of a reflected wave spectrum for each state of the sensor.

### Advantageous Effects of Invention

With a state detection system according to the present disclosure, it is possible to detect a state change of an object or an environment with high accuracy.

### BRIEF DESCRIPTION OF DRAWINGS

FIG. 1 is a diagram illustrating an example of a configuration of a state detection system.

FIG. 2 is a diagram illustrating an example of a configuration of a sensor.

FIG. 3 is a diagram illustrating an example of a reflected wave spectrum (frequency spectrum of a reflected wave) of the sensor acquired by a reader.

Each of FIGS. 4A, 4B, and 4C is a diagram illustrating an example of a change in a reflected wave spectrum of the sensor caused by a state change of a detection target of the sensor.

FIG. 5 is a diagram illustrating a more preferable form of the sensor.

FIG. 6 is a diagram illustrating a mode in which the sensor detects an expansion/contraction state of an object to be detected.

FIG. 7 is a diagram illustrating a mode in which the sensor detects a change in the thickness of an object to be detected.

FIG. 8 is a diagram illustrating a mode in which the sensor detects a positional displacement state of an object to be detected.

FIG. 9 is a diagram illustrating a mode in which the sensor detects a change in the moisture content of an object to be detected.

FIG. 10 is a diagram illustrating a mode in which the sensor detects a change in the temperature of a surrounding environment.

FIG. 11 is a diagram illustrating a mode in which the sensor detects a change in the gas concentration of a surrounding environment.

FIG. 12 is a diagram illustrating a mode in which the sensor detects the degree of oxidation of an object to be detected.

FIG. 13 is a diagram illustrating a modification example of the configuration of the sensor.

FIG. 14 is an example of a flowchart when learning processing is performed on a learning model.

FIG. 15 is an example of a flowchart of processing of estimating a state of a detection target.

FIG. 16 is a diagram illustrating a configuration of Example 1.

FIG. 17 is a diagram illustrating a representative reflected wave spectrum obtained each time of estimation of the moisture absorption amount in a diaper.

FIG. 18 is a diagram illustrating a configuration of Example 2.

FIG. 19 is a diagram illustrating a representative reflected wave spectrum obtained for each cup position of the paper cup.

FIG. 20 is a diagram illustrating a configuration of Example 3.

FIG. 21 is a diagram illustrating representative reflected wave spectra in respective states where a substrate is not stretched, 1% stretched, 2% stretched, and 3% stretched.

FIG. 22 is a diagram illustrating a configuration of Example 4.

### DESCRIPTION OF EMBODIMENTS

Hereinbelow, preferred embodiments of the present disclosure will be described in detail with reference to the accompanying drawings. Note that, in the present description and the drawings, components having substantially the same function are labeled with the same reference signs, and redundant description is omitted.

[Basic Configuration of State Detection System]

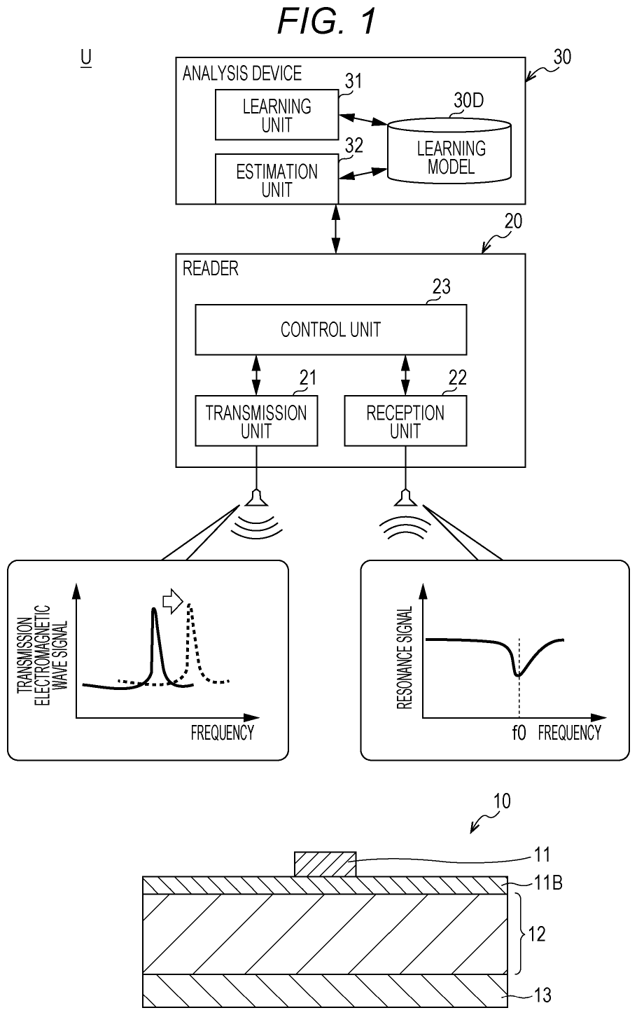

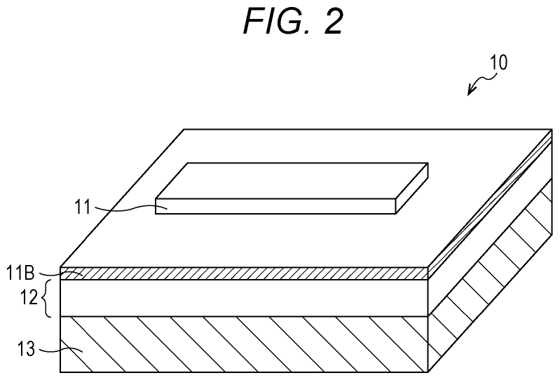

First, a basic configuration of a state detection system according to an embodiment will be described with reference to FIGS. 1 and 2.

FIG. 1 is a diagram illustrating an example of a configuration of a state detection system U.

The state detection system U includes a sensor 10, a reader 20, and an analysis device 30.

Here, the sensor 10 includes an electromagnetic wave reflecting material and a resonator disposed adjacent to or integrally with the electromagnetic wave reflecting material, and detects a state change of a surrounding object or surrounding environment around itself as a change in its own electromagnetic wave reflection characteristic (hereinbelow referred to as “a reflection characteristic of the sensor 10” or “a reflected wave spectrum of the sensor 10). The reader 20 transmits an electromagnetic wave to the sensor 10 while changing the transmission frequency, receives a reflected wave thereof, and acquires data of a current reflected wave spectrum of the sensor 10. The analysis device 30 estimates a current state of a detection target of the sensor 10 using a pre-trained learning model 30D on the basis of the data of the current reflected wave spectrum of the sensor 10.

In such a configuration, the state detection system U can estimate the current state of the detection target of the sensor 10 with high accuracy from the change in the reflection characteristic of the sensor 10.

[Configuration of Sensor]

FIG. 2 is a diagram illustrating an example of a configuration of the sensor 10.

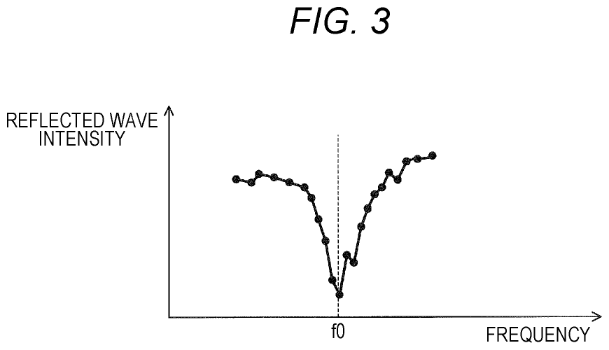

FIG. 3 is a diagram illustrating an example of a reflected wave spectrum (frequency spectrum of a reflected wave) of the sensor 10 acquired by the reader 20. Note that the plotted points in FIG. 3 are data of the reflected wave intensity at each transmission frequency acquired by the reader 20.

FIG. 4 is a diagram illustrating an example of a change in a reflected wave spectrum of the sensor 10 caused by a state change of a detection target of the sensor 10.

The sensor 10 includes a resonator 11, an isolation layer 12, and an electromagnetic wave reflecting material 13 in order from the upper surface side (the side opposed to the reader 20). Note that, hereinbelow, for convenience of description, the side opposed to the reader 20 is referred to as an upper side, and the side opposed to the reader 20 is referred to as a lower side.

The resonator 11 is, for example, a metal pattern formed on a substrate 11B. The resonator 11 is formed in a strip shape by, for example, a metal pattern, and has a resonance structure that resonates when irradiated with an electromagnetic wave of a predetermined frequency. Then, for example, the resonator 11 absorbs an electromagnetic wave having a frequency matching its own resonance frequency (in FIGS. 1 and 3, when the frequency of the electromagnetic wave is f0), and reflects an electromagnetic wave having a frequency other than the above frequency when irradiated with the electromagnetic wave.

The resonance frequency of the resonator 11 is determined by the shape (mainly the length) of the metal pattern forming the resonator 11. In general, when the maximum length of the resonator 11 is ½λ of the frequency of the electromagnetic wave, the resonator 11 resonates and exhibits an absorption peak at which the intensity of the reflected wave at the frequency corresponding to the resonator length is low.

The resonator 11 may include only one resonator as illustrated in FIG. 2, but may include a plurality of resonators in order to heighten the intensity of the reflected wave. In addition, from the viewpoint of diversifying the patterns of the reflected wave spectrum, the resonator 11 may include, for example, a plurality of resonators having different lengths so that the sensor 10 has a plurality of resonance frequencies.

As a method of forming the resonator 11 on the substrate 11B, any method such as a printing method and pattern etching may be used. Also, as a material for the resonator 11, a metal material such as copper, silver, gold, and aluminum is used. Note that, to cause the resonator 11 to have elasticity, it is preferable to use a metal material containing a binder or the like as a material for the resonator 11.

As the substrate 11B on which the resonator 11 is formed, a material having electromagnetic wave permeability such as paper and resin is used. However, the form of the substrate 11B is not limited to a plate shape, and may be a curved shape, a cylindrical shape, or the like. In other words, the resonator 11 may be formed directly on an article, such as a packaging material and a container. Furthermore, the substrate 11B may be an object itself to be detected by the sensor 10.

The isolation layer 12 is a space in which an insulating material or no object is arranged, is disposed between the resonator 11 and the electromagnetic wave reflecting material 13, and insulates the resonator 11 and the electromagnetic wave reflecting material 13 from each other.

In a case where a space in which no object is arranged (filled with air) or a material having a low dielectric constant such as a foamed resin is used as the isolation layer 12, a resonance phenomenon occurring in the resonator 11 is further amplified. Also, the isolation layer 12 is adjacent to the resonator 11. Hence, when the dielectric constant of the isolation layer 12 changes, the resonance frequency of the resonator 11 changes due to the wavelength shortening effect of the dielectric. That is, the change in the dielectric constant of the isolation layer 12 appears as a change in the resonance frequency of the resonator 11 in the reflection characteristic of the sensor 10.

The electromagnetic wave reflecting material 13 is disposed to be opposed to the resonator 11 with the isolation layer 12 interposed therebetween, and reflects the electromagnetic wave emitted from the reader 20 to the sensor 10. The electromagnetic wave reflecting material 13 is, for example, a metal plate (for example, an aluminum plate) disposed in parallel with the substrate 11B on which the resonator 11 is formed. The electromagnetic wave reflecting material 13 is disposed over a larger region than a region where the resonator 11 is formed at a position opposed to the resonator 11 in a planar view.

In addition, the electromagnetic wave reflecting material 13 also functions to amplify a resonance phenomenon occurring in the resonator 11. Specifically, in a case where the electromagnetic wave reflecting material 13 is present, a resonance phenomenon occurring in the resonator 11 also occurs between the resonator 11 and the electromagnetic wave reflecting material 13, and the resonance phenomenon is amplified. That is, the electromagnetic wave reflecting material 13 makes the resonance peak (absorption peak) significant in a case where the resonance phenomenon occurs in the resonator 11. In this manner, by disposing the electromagnetic wave reflecting material 13 on the back surface of the resonator 11, it is possible to enhance the contrast of the intensity of the reflected wave between the reflected wave generated in the sensor 10 at the time of resonance and the reflected wave generated in the sensor 10 at the time of non-resonance.

Note that, since the electromagnetic wave reflecting material 13 reflects the electromagnetic wave toward the reader 20 regardless of whether or not the frequency of the electromagnetic wave emitted from the reader 20 coincides with the resonance frequency of the resonator 11, in the reflected wave spectrum of the sensor 10, the intensity of the reflected wave from the electromagnetic wave reflecting material 13 appears as the reflection intensity in the baseband region (hereinbelow, the region other than the resonance peak). Also, the electromagnetic wave reflecting material 13 acts to make the resonance peak of the resonator 11 significant. Hence, in a case where the area of the region of the electromagnetic wave reflecting material 13 opposed to the resonator 11 changes, the change appears in the reflected wave spectrum of the sensor 10 as lowering of the reflection intensity in the baseband region and lowering of the peak intensity of the resonance peak (see FIGS. 4B and 4C).

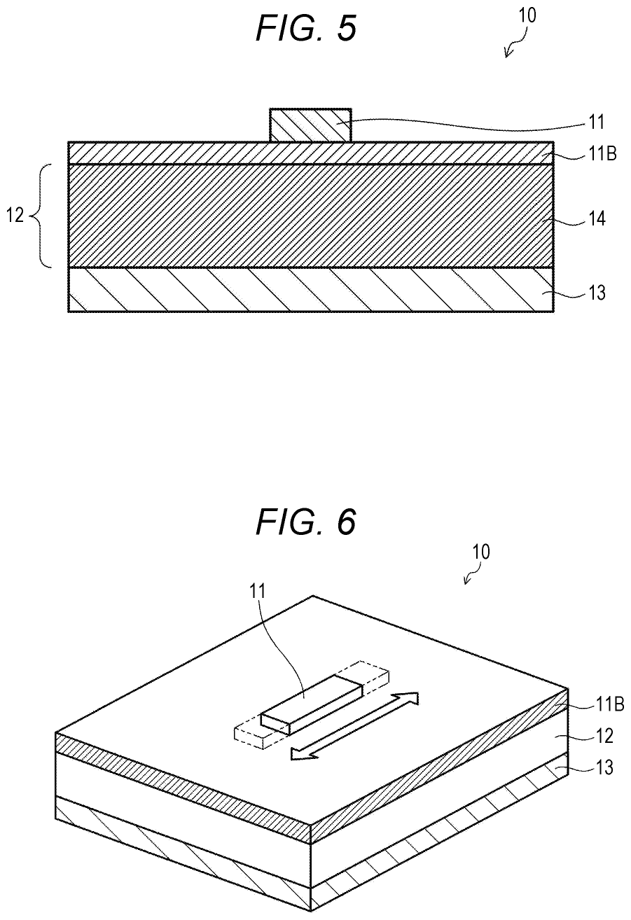

In such a mode, the sensor 10 is configured such that at least any of the states of the resonator 11, the isolation layer 12, and the electromagnetic wave reflecting material 13 is interlocked with a state change of a detection target (described below with reference to FIGS. 6 to 12). Then, the sensor 10 causes the reader 20 to detect the state change of the detection target by the change in the reflection characteristic of the reflected wave generated when the reader 20 emits the electromagnetic wave.

The state change to be detected by the sensor 10 is, for example, any of a change in the position of the surrounding object around the sensor 10, a change in the form of the surrounding object around the sensor 10, a change in the moisture content of the surrounding object around the sensor 10, a change in the humidity of the surrounding environment around the sensor 10, a change in the temperature of the surrounding environment around the sensor 10, a change in the gas concentration of the surrounding environment around the sensor 10, a change in the light illuminance of the surrounding environment around the sensor 10, a change in the pH of the surrounding environment around the sensor 10, a change in the magnetic field of the surrounding environment around the sensor 10, and a change in the degree of oxidation of the surrounding object around the sensor 10.

At this time, the state of the detection target is typically detected as a change in the resonance peak position (that is, the resonance frequency) (see FIG. 4A), a change in the peak intensity of the resonance peak (see FIG. 4B), or a change in the reflection intensity in the baseband region (see FIG. 4C) in the reflected wave spectrum of the sensor 10.

However, as described above, in practice, it is often difficult to accurately identify the resonance frequency of the sensor 10 from the reflected wave spectrum of the sensor 10, and there is a possibility that the state change of the detection target cannot accurately be captured by the peak pick method as in the conventional technique in Patent Literature 1. Under such circumstances, in the state change system U according to the present embodiment, the state of the sensor 10 (that is, the state of the detection target) is identified from the entire pattern of the reflected wave spectrum of the sensor 10 without performing the processing of identifying the resonance frequency from the reflected wave spectrum of the sensor 10. Note that the “entire pattern of the reflected wave spectrum of the sensor 10” mentioned here means the reflection intensities at a plurality of frequency positions in the reflected wave spectrum of the sensor 10. In the state change system U (analysis device 30 to be described below) according to the present embodiment, in order to identify the state of the sensor 10, information regarding the reflection intensities at least at three frequency positions (for example, three frequency positions across the resonance frequency determined from the design information of the resonator 11) is referred to.

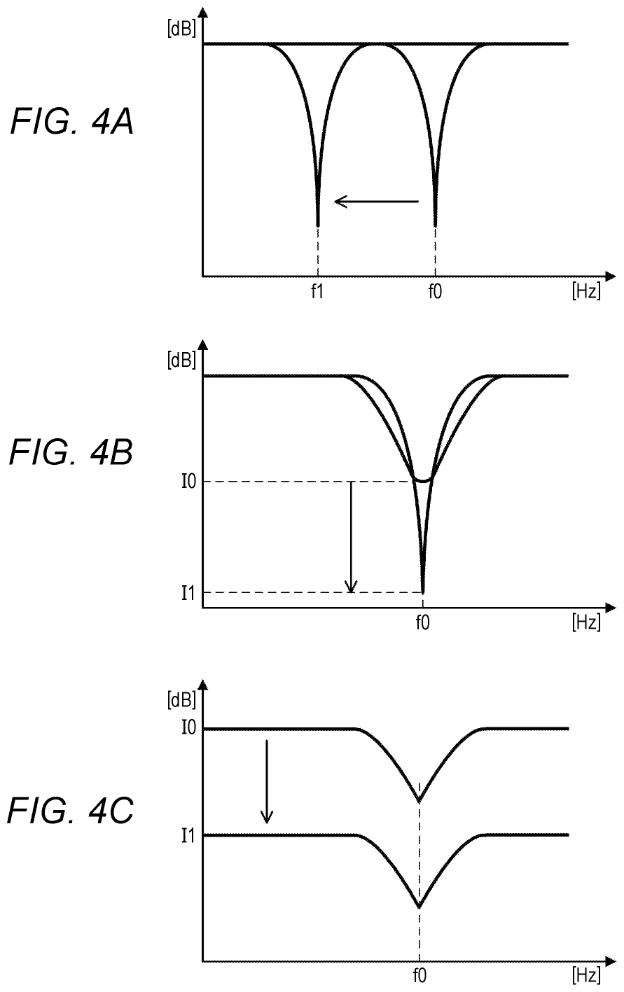

FIG. 5 is a diagram illustrating a more preferable form of the sensor 10.

As illustrated in FIG. 5, the sensor 10 preferably includes a sensitizer 14 that has sensitivity to a state change of a detection target of the sensor 10 and changes a reflection characteristic of the sensor 10 in accordance with the state change of the detection target of the sensor 10.

The sensitizer 14 is made of a material corresponding to a detection target of the sensor 10. For example, in a case where the detection target of the sensor 10 is the moisture content of the surrounding object or the humidity of the surrounding environment, a moisture absorbing material is used as the sensitizer 14. Also, in a case where the detection target of the sensor 10 is the light amount of the surrounding environment, a material having photoresponsiveness is used as the sensitizer 14. Also, in a case where the detection target of the sensor 10 is the magnetic intensity of the surrounding environment, a magnetic fluid is used as the sensitizer 14. Also, in a case where the detection target of the sensor 10 is the degree of oxidation of the surrounding object, a metal having different corrosiveness from that of the detection target of the sensor 10 is used as the sensitizer 14. Also, in a case where the detection target of the sensor 10 is the temperature of the surrounding environment, a material having thermal expansion characteristics is used as the sensitizer 14. Also, in a case where the detection target of the sensor 10 is the form of the surrounding object, a pressure-sensitive material is used as the sensitizer 14. Also, in a case where the detection target of the sensor 10 is the pH of the surrounding environment, a chemical substance absorbing material is used as the sensitizer 14.

In the sensor 10, the function of the sensitizer 14 is exhibited by affecting the dielectric constant of the proximity region of the resonator 11, the tanδ of the proximity region of the resonator 11, the conductivity of the electromagnetic wave reflecting material 13, or the magnetic constant of the proximity region of the resonator 11. That is, the sensitizer 14 amplifies a change in the reflected wave spectrum of the sensor 10 (for example, the frequency shift of the resonance frequency, the peak intensity of the resonance peak, or the reflection intensity in the baseband region) when the state of the detection target of the sensor 10 changes.

As illustrated in FIG. 5, the sensitizer 14 is preferably disposed in the isolation layer 12 of the sensor 10. With such a disposing position, it is possible to more effectively change the reflected wave spectrum of the sensor 10 when the state of the detection target of the sensor 10 changes.

However, the disposing position of the sensitizer 14 may be any position as long as the function of sensitization is exhibited. For example, the sensitizer 14 does not have to be disposed in the isolation layer 12, and may be disposed so as to cover the upper surface of the resonator 11 or may be disposed at the lateral portion of the resonator 11. Also, the sensitizer 14 may be disposed on the lower surface side of the electromagnetic wave reflecting material 13, or may be disposed apart from the resonator 11 and the electromagnetic wave reflecting material 13.

FIGS. 6 to 12 illustrate various examples of a configuration for detecting a state change of a surrounding object or a surrounding environment by the sensor 10.

FIG. 6 is a diagram illustrating a mode in which the sensor 10 detects an expansion/contraction state of an object to be detected. In this mode, for example, the resonator 11 of the sensor 10 is made of a member that can expand and contract in the longitudinal direction. The sensor 10 then detects the expansion/contraction state of the object to be detected as a change in the length of the resonator 11. Note that the change in the length of the resonator 11 appears as a change in the resonance frequency in the reflected wave spectrum of the sensor 10.

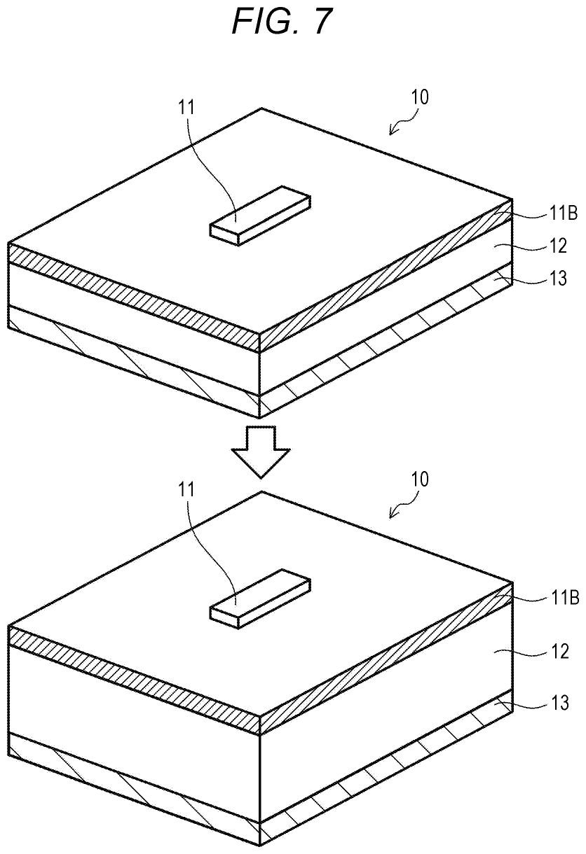

FIG. 7 is a diagram illustrating a mode in which the sensor 10 detects a change in the thickness of an object to be detected. In this mode, for example, the sensor 10 is configured such that the thickness of the isolation layer 12 (that is, the distance between the resonator 11 and the electromagnetic wave reflecting material 13) changes in conjunction with the thickness of the object to be detected. The sensor 10 then detects the thickness of the object to be detected as a change in the thickness of the isolation layer 12. Note that, in the structure of the sensor 10 illustrated in FIG. 2, in general, the intensity of the reflected wave from the sensor 10 is the most significant when the distance between the resonator 11 and the electromagnetic wave reflecting material 13 is a predetermined distance, and is less significant as the distance between the resonator 11 and the electromagnetic wave reflecting material 13 is away from the predetermined distance. That is, the change in the thickness of the isolation layer 12 appears as a change in the peak intensity of the resonance peak in the reflected wave spectrum of the sensor 10.

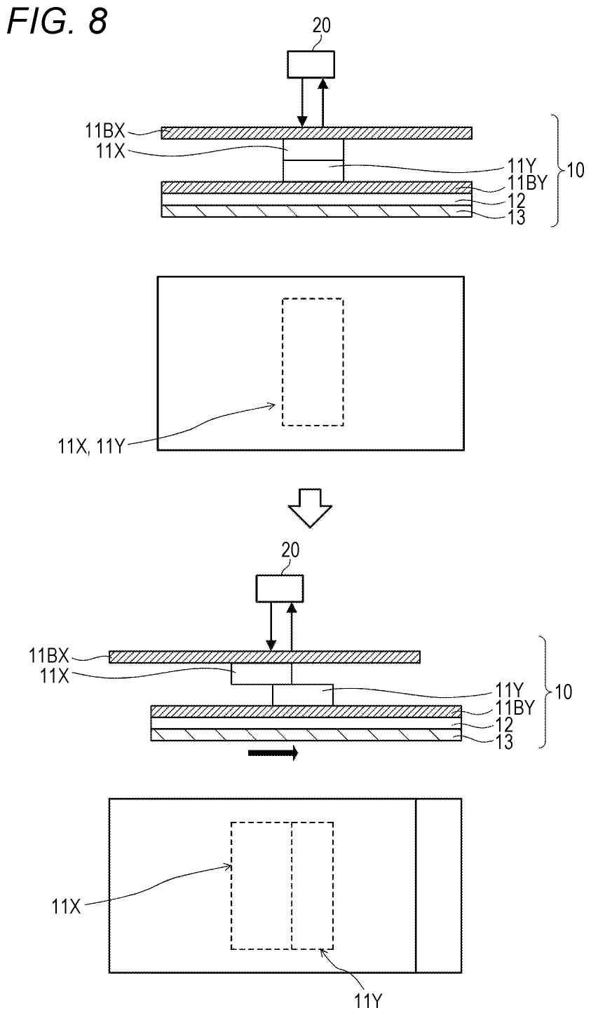

FIG. 8 is a diagram illustrating a mode in which the sensor 10 detects a positional displacement state of an object to be detected. In this mode, for example, the sensor 10 includes a first resonator 11X attached to a first object 11BX and a second resonator 11Y attached to a second object 11BY so as to be opposed to the first resonator 11X, and is configured such that the positional relationship between the first resonator 11X and the second resonator 11Y can be changed in response to the positional displacement between the first object 11BX and the second object 11BY. The sensor 10 then detects the positional displacement state between the first object 11BX and the second object 11BY as a change in the area in which the first resonator 11X and the second resonator 11Y are opposed. The change in the area in which the first resonator 11X and the second resonator 11Y are opposed appears as a change in the peak intensity of the resonance peak or a change in the resonance frequency in the reflected wave spectrum of the sensor 10.

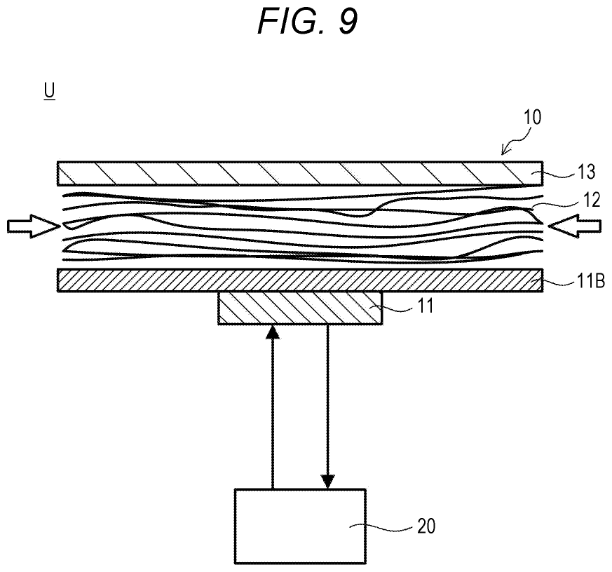

FIG. 9 is a diagram illustrating a mode in which the sensor 10 detects a change in the moisture content of an object to be detected. In this mode, for example, the sensor 10 has a structure in which a part of the object to be detected is arranged in the isolation layer 12, and is configured such that a liquid N3 can enter the isolation layer 12 from the periphery. The sensor 10 then detects a change in the moisture content of the object to be detected as a change in the dielectric constant of the isolation layer 12. Note that the change in the dielectric constant change of the isolation layer 12 appears as a change in the resonance frequency of the resonator 11 in the reflected wave spectrum of the sensor 10.

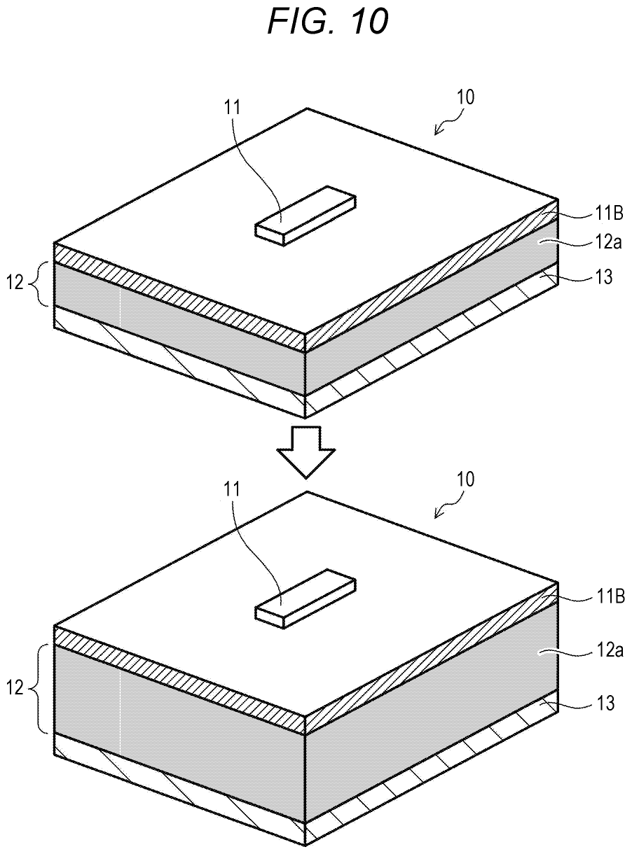

FIG. 10 is a diagram illustrating a mode in which the sensor 10 detects a change in the temperature of a surrounding environment. In this mode, for example, the sensor 10 includes a thermal expansion material as the sensitizer 14 in the isolation layer 12, and is configured such that surrounding air can enter the isolation layer 12. The sensor 10 then detects a change in the temperature of the surrounding environment as a change in the thickness of the isolation layer 12. Note that the change in the thickness of the isolation layer 12 appears as a change in the peak intensity of the resonance peak in the reflected wave spectrum of the sensor 10.

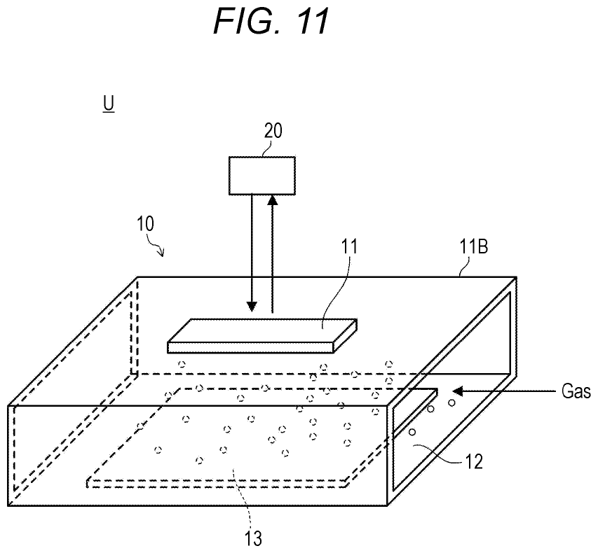

FIG. 11 is a diagram illustrating a mode in which the sensor 10 detects a change in the gas concentration of a surrounding environment. In this mode, for example, the isolation layer 12 of the sensor 10 is formed as a space in a pipe through which a gas flows. The sensor 10 then detects a change in the gas concentration as a change in the dielectric constant of the isolation layer 12. Note that the change in the dielectric constant change of the isolation layer 12 appears as a change in the resonance frequency of the resonator 11 in the reflected wave spectrum of the sensor 10.

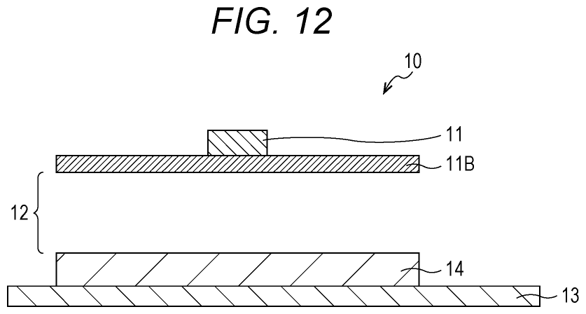

FIG. 12 is a diagram illustrating a mode in which the sensor 10 detects the degree of oxidation of an object to be detected. In this mode, for example, the electromagnetic wave reflecting material 13 of the sensor 10 is configured as a part of the object to be detected. In the sensor 10, a metal material having a higher corrosion rate than the object to be detected (for example, the ionization tendency thereof is higher than that of the object to be detected) is disposed as the sensitizer 14 at a position opposed to the resonator 11. The sensor 10 then detects the degree of oxidation of the object to be detected as a change in the conductivity of the electromagnetic wave reflecting material 13. Note that the change in the conductivity of the electromagnetic wave reflecting material 13 appears as a change in the peak intensity of the resonance peak and a change in the reflection intensity in the baseband region in the reflected wave spectrum of the sensor 10.

### Modification Example of Sensor

The sensor 10 usable in the state detection system U according to the present disclosure is not limited to one having the structure in FIG. 2 as long as the sensor 10 has a resonator structure capable of resonating in response to the transmitted electromagnetic wave.

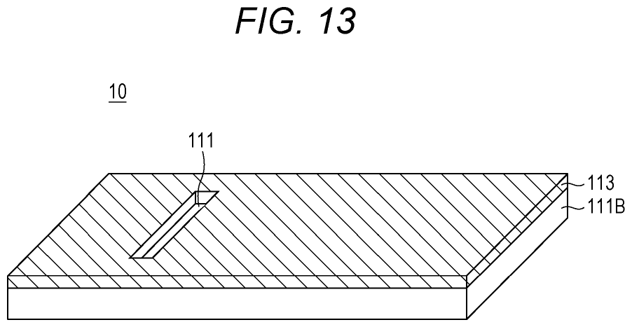

FIG. 13 is a diagram illustrating a modification example of the configuration of the sensor 10. The sensor 10 according to the modification example includes an electromagnetic wave reflecting material 113 and a slot-type resonator 111 formed in the electromagnetic wave reflecting material 113. The electromagnetic wave reflecting material 113 is formed on a substrate 111B, for example.

The electromagnetic wave reflecting material 113 is, for example, a conductor pattern layer formed on the substrate 111B, and is made of a conductive material such as an aluminum material and a copper material. The conductor pattern layer of the electromagnetic wave reflecting material 113 has a rectangular slot formed by partially cutting out the solid conductor layer, and the resonator 111 is formed by the slot. Typically, the resonator 111 resonates when the length of the slot corresponds to about λ/2 of the wavelength of the emitted electromagnetic wave.

The reflected wave spectrum of the sensor 10 according to the modification example shows a spectrum similar to that in FIG. 3. That is, when the resonator 111 resonates, an absorption peak appears, and in a frequency band other than the resonance frequency of the resonator 111, intensity information caused by a reflected wave from the electromagnetic wave reflecting material 113 appears in the baseband region.

Note that the sensor 10 according to the modification example is also preferably provided with the sensitizer 14. Note that the resonator structure in FIG. 13 may be applied as the resonator 11 in FIG. 2.

[Configuration of Reader]

The reader 20 includes a transmission unit 21, a reception unit 22, and a control unit 23. Note that, for example, the reader 20 is disposed at a position away from the sensor 10 by several cm to several m so as to be opposed to the upper surface of the sensor 10.

The transmission unit 21 transmits an electromagnetic wave of a predetermined frequency to the sensor 10. The transmission unit 21 includes, for example, a transmission antenna, an oscillator, and the like.

The transmission unit 21 transmits, for example, a sinusoidal electromagnetic wave having a peak intensity at a single frequency. Then, the transmission unit 21 temporally changes the transmission frequency of the electromagnetic wave to be transmitted from the transmission antenna, and performs a frequency sweep within a preset predetermined frequency band. Alternatively, the transmission unit 21 may collectively emit at a time an electromagnetic wave having a specific intensity profile in a predetermined frequency band (that is, the impulse method).

The frequency band in which the reflected wave spectrum is acquired is, for example, an HF band, a UHF band, a UWB frequency band (3.1 GHz to 10.6 GHz), a 24 GHz band, a millimeter wave band, or the like. Then, the transmission frequency of the transmission unit 21 is set stepwise at every bandwidth of at least 500 MHz or less, preferably at every bandwidth of 10 MHz, within the frequency band. Note that the frequency band of the electromagnetic wave transmitted by the transmission unit 21 is set to include the resonance frequency of the resonator 11 of the sensor 10.

The reception unit 22 receives a reflected wave from the sensor 10 generated when the transmission unit 21 transmits an electromagnetic wave. The reception unit 22 includes, for example, a reception antenna and a reception signal processing circuit that detects the intensity and phase of the reflected wave on the basis of the reception signal of the reflected wave acquired by the reception antenna. Then, the reception unit 22 generates reflected wave spectrum information (frequency spectrum data) of the sensor 10 from the intensity of the reflected wave detected at each transmission frequency of the electromagnetic wave, for example. Note that, when generating the reflected wave spectrum information of the sensor 10, the reception unit 22 may use the intensity itself of the reflected wave or may use the intensity ratio between the intensity of the transmission wave and the intensity of the reflected wave. Furthermore, the reflected wave spectrum information may include phase characteristic information in addition to amplitude characteristic information for each frequency.

Note that the transmission unit 21 and the signal processing circuit of the reception unit 22 may be configured integrally by a vector network analyzer.

The control unit 23 comprehensively controls the reader 20. Note that, for example, in order to sequentially monitor the state of the object to be detected, the control unit 23 causes the transmission unit 21 and the reception unit 22 to execute the above-described processing at predetermined time intervals.

Note that, in order to improve the sensitivity of the sensitive material (for example, the sensitizer 14) built in the sensor 10, the reader 20 may collect the reflected wave spectrum information of the sensor 10 while applying an external stimulus different, in nature, from the state change of the detection target to the sensor 10. For example, the reader 20 may collect the reflected wave spectrum information of the sensor 10 while applying light, heat, or ultrasonic waves to the sensor 10. As a result, for example, the moisture absorption property, photoresponsiveness, thermal expansion property, chemical substance absorption property, or the like of the sensitive material (for example, the sensitizer 14) can temporarily be increased, and a change from the reference state of the reflected wave spectrum of the sensor 10 can be captured more easily.

[Configuration of Analysis Device]

The analysis device 30 acquires current reflected wave spectrum information of the sensor 10 from the reader 20, and estimates a current state of a detection target of the sensor 10 on the basis of the current reflected wave spectrum information of the sensor 10. Note that the analysis device 30 is, for example, a computer including a central processing unit (CPU), a read only memory (ROM), a random access memory (RAM), an input port, an output port, and the like, and is configured to be able to perform data communication with the reader 20.

The analysis device 30 includes a learning unit 31 that performs learning processing on the learning model 30D using training data, and an estimation unit 32 that estimates a current state of a detection target of the sensor 10 by applying information regarding reflected wave intensities at a plurality of frequency positions of a current reflected wave spectrum of the sensor 10 to the learning model 30D.

That is, the analysis device 30 uses the learning model 30D to detect the state of the sensor 10 from the pattern of the reflected wave spectrum of the sensor 10 instead of the mode of detecting the state of the sensor 10 using the peak pick method as in the conventional technique in Patent Literature 1.

Here, as the learning model 30D used by the analysis device 30, a model optimized by machine learning is typically used. As the learning model 30D, for example, support vector machine (SVM), k-nearest neighbor, logistic regression, Lasso regression, ridge regression, elastic net regression, support vector regression, a decision tree, or the like is used. Note that the configuration of the learning model 30D is similar to that of a known model, and thus description thereof is omitted here.

This type of learning model 30D is subjected to learning processing to extract features of the pattern to be identified, and is autonomously optimized so that the pattern to be identified can accurately be identified even from data on which noise or the like is superimposed. In this regard, the reflected wave spectrum of the sensor 10 draws a unique pattern around the resonance peak position of the resonator 11 for each state of the detection target. That is, the learning model 30D of this type is subjected to learning processing, using the reflected wave spectrum information, with the state of the detection target as a label, as training data. Hence, when certain reflected wave spectrum information is input, the learning model 30D can identify the state of the most similar reflected wave spectrum information among pieces of reflected wave spectrum information for respective states used as the training data. In particular, at this time, training data is also prepared for various pieces of reflected wave spectrum information, assuming various situation changes having different positional relationships with the reader 20, and the learning processing is performed using these various pieces of reflected wave spectrum information, whereby the learning model 30D obtains a high generalization ability.

The hyperparameter of the learning model 30D is optimized by a known learning algorithm, and as a method of the optimization, grid search may be used, for example. Furthermore, as the learning algorithm for the learning model 30D, for example, ensemble learning using at least one of SVM, k-nearest neighbor, logistic regression, Lasso regression, ridge regression, elastic net regression, support vector regression, and a decision tree may be used.

For example, the learning model 30D has a configuration in which reflected wave intensities at a plurality of frequency positions of a reflected wave spectrum (for example, respective plotted points in FIG. 3) are input, and in which a state of a detection target is output.

Here, each of the frequency positions of the reflected wave intensities to be input into the learning model 30D is set at every bandwidth of at least 500 MHz, preferably at every bandwidth of 10 MHz within the frequency band in which the reflected wave spectrum information is acquired. The frequency positions preferably include a resonance frequency in a standard state of the resonator 11 of the sensor 10 or a frequency in the vicinity thereof. Note that the reflected wave spectrum information input into the learning model 30D may include phase characteristic information in addition to amplitude characteristic information for each frequency.

Furthermore, the state of the detection target output by the learning model 30D may be the state of the detection target (for example, a moisture content value, or a gas concentration value) expressed quantitatively by a numerical value, or may be one by which the level of the change amount from the reference state of the detection target can be identified, such as “change amount: large”, “change amount: medium”, and “change amount: small” (hereinbelow, collectively referred to as a “state change amount”.). In other words, the learning model 30D may be configured as a regression learning model or may be configured as a classification learning model.

However, as the learning model 30D used by the analysis device 30, a model optimized by multiple regression analysis may be used instead of the model optimized by machine learning.

For example, the learning unit 31 performs learning processing on the learning model 30D using, as training data, reflected wave spectrum information for each state (that is, for each state of the detection target) of the sensor 10 obtained by actual measurement or simulation. That is, the learning unit 31 performs learning processing on the learning model 30D using, as training data, reflected wave spectrum information of the sensor 10 in each of various states to which a label corresponding to each state change amount of the detection target is assigned as true data. As a result, the learning model 30D is optimized so as to be able to output the state change amount of the detection target in a case where the reflected wave spectrum having a pattern conforming to the input reflected wave spectrum is generated.

Note that, in a case where the learning model 30D is, for example, a classification learning model, the reflected wave spectrum information of the sensor 10 used as the training data is reflected wave spectrum information for each state of the candidate to be classified. On the other hand, in a case where the learning model 30D is a regression learning model, the data may be pieces of reflected wave spectrum information for respective arbitrary state change amounts as long as pieces of reflected wave spectrum information for a plurality of states are included.

The estimation unit 32 inputs information of reflected wave intensities at a plurality of frequency positions of current reflected wave spectrum information of the sensor 10 into the learning model 30D on which the learning processing has been performed by the learning unit 31 (see the plotted points in FIG. 3), and estimates a current state of a detection target of the sensor 10 from an output result of the learning model 30D. Note that the reflected wave intensities at the plurality of frequency positions of the current reflected wave spectrum information of the sensor 10 that the estimation unit 32 inputs into the learning model 30D are typically reflected wave intensities at the same frequency positions as the frequency positions referred to when the learning processing is performed on the learning model 30D.

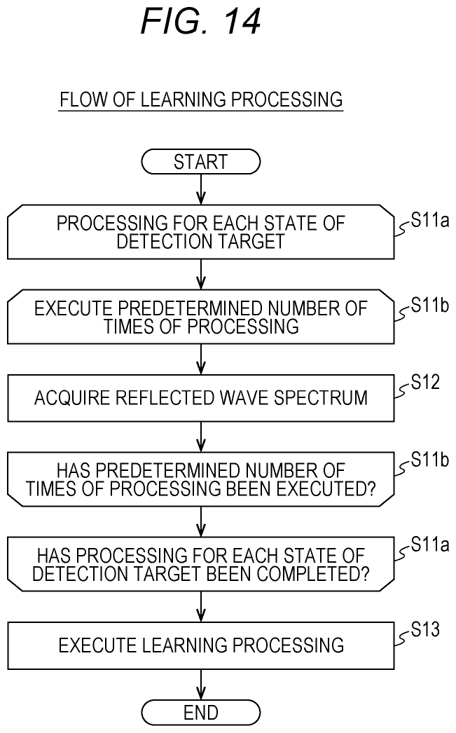

FIG. 14 is an example of a flowchart when learning processing is performed on the learning model 30D. Note that, here, the reader 20 and the analysis device 30 execute each step in accordance with a command from the developer.

In this flowchart, a reflected wave spectrum of the sensor 10 is repeatedly acquired in the loop processing in step S11a and the loop processing in step S11b (step S12).

Here, the loop processing in step S11a is processing of acquiring a reflected wave spectrum of the sensor 10 for each state of the detection target of the sensor 10. In this loop processing, for example, in a case where there are four types of state to be identified by the sensor 10, a reflected wave spectrum of the sensor 10 is acquired for each of the four types of state. Note that, at this time, the state of the detection target of the sensor 10 may be changed manually by the developer, or may be changed by changing the surrounding environment of the sensor 10 by means of an external device.

Also, the loop processing in step S11b is processing of acquiring a reflected wave spectrum of the sensor 10 a predetermined number of times while changing the orientation of the sensor 10 and the object around the sensor 10.

The loop processing in step S11b is data acquisition processing for making the learning model 30D a model with higher robustness. Even if the state change amounts of the detection target are the same, the reflected wave spectra may slightly differ depending on the orientation of the sensor 10 or the object around the sensor 10. From such a viewpoint, pieces of reflected wave spectrum information are acquired under various conditions where the orientations of the sensor 10 and the objects around the sensor 10 are different as training data pieces, and machine learning is performed on the learning model 30D using the training data pieces. Note that, for the training data pieces acquired at this time, true values of the same state change amounts will be set.

After the loop processing in step S11a and the loop processing in step S11b are completed, the analysis device 30 (learning unit 31) executes learning processing on the learning model 30D using a known machine learning algorithm with these pieces of reflected wave spectrum information as training data (step S13).

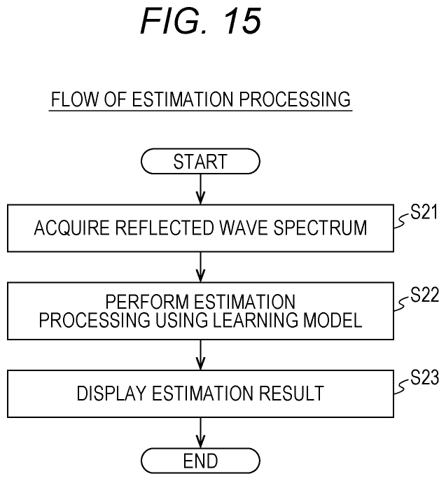

FIG. 15 is an example of a flowchart of processing of estimating a state of a detection target.

In step S21, the reader 20 transmits an electromagnetic wave from the transmission antenna to the sensor 10 while changing the transmission frequency, and receives a reflected wave from the sensor 10 by means of the reception antenna. As a result, the reader 20 acquires current reflected wave spectrum information of the sensor 10.

In step S22, the analysis device 30 (estimation unit 32) inputs the current reflected wave spectrum information of the sensor 10 into the pre-trained learning model 30D, and calculates a state change amount of the detection target using the learning model 30D.

In step S23, the analysis device 30 (estimation unit 32) displays the state change amount of the detection target calculated in step S22 on a display unit (not illustrated).

[Verification Experiment]

Next, a result of verifying the accuracy of the estimation processing of the state detection system U according to the present disclosure will be shown.

### Example 1

In Example 1, the state detection system U according to the present disclosure is applied to estimation of the moisture absorption amount of a diaper.

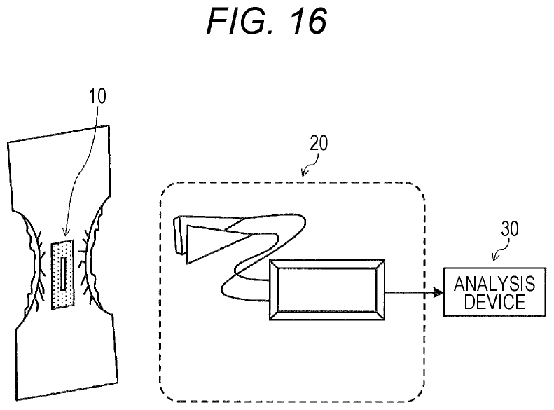

FIG. 16 is a diagram illustrating a configuration of Example 1. Example 1 verified, when the sensor 10 was attached to a diaper, and a predetermined amount of water was absorbed in the diaper, whether or not the moisture absorption amount could be identified accurately.

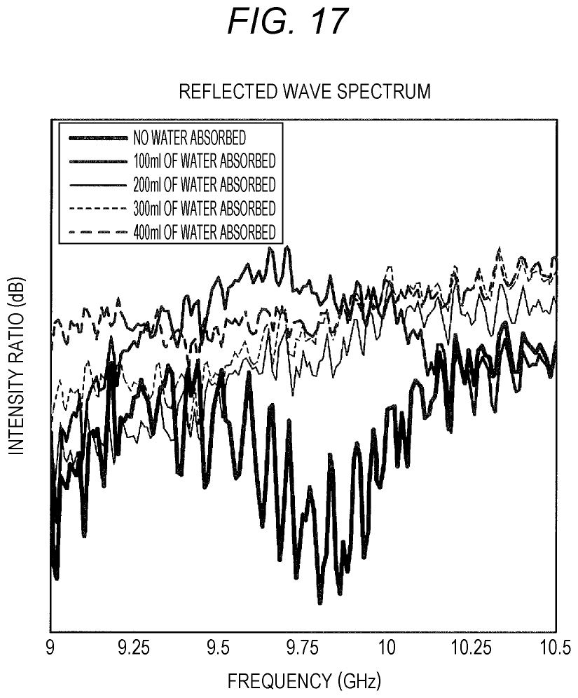

FIG. 17 is a diagram illustrating a representative reflected wave spectrum obtained each time of estimation of the moisture absorption amount in a diaper. Here, reflected wave spectra were acquired when 100 ml, 200 ml, 300 ml, and 400 ml of water were absorbed in a diaper. Note that, in each learning processing on the learning model to be described below, the reflected wave spectrum information in each state in FIG. 17 was used.

Table 1 is a table illustrating various estimation methods used in Example 1 and evaluation results thereof.

TABLE 1

| | Estimation | | Number of | Learning | Ensemble | Accuracy |
|---|---|---|---|---|---|---|
| Example No. | method | Sensitizer | analysis points | model | learning | rate |
| Comparative | Peak | Not | 1 | Single | — | Estimation |
| Example 1-1 | pick | provided | | regression | | impossible |
| | | | | model | | |
| Comparative | Single | Not | 1 | Single | — | 14% |
| Example 1-2 | regression | provided | | regression | | |
| | analysis | | | model | | |
| Example 1-1 | Multiple | Not | 3 | Multiple | — | 60% |
| | regression | provided | | regression | | |
| | analysis | | | model | | |
| Example 1-2 | Machine | Not | 3 | SVM | — | 72% |
| | learning | provided | | | | |
| Example 1-3 | Machine | Not | 1 at every | SVM | — | 83% |
| | learning | provided | 10 MHz | | | |
| Example 1-4 | Machine | Not | 1 at every | k-nearest | — | 82% |
| | learning | provided | 10 MHz | neighbor | | |
| Example 1-5 | Machine | Not | 1 at every | SVM | ◯ | 92% |
| | learning | provided | 10 MHz | | | |
| Example 1-6 | Multiple | Provided | 3 | Multiple | — | 67% |
| | regression | | | regression | | |
| | analysis | | | model | | |
| Example 1-7 | Machine | Provided | 1 at every | SVM | ◯ | 98% |
| | learning | | 10 MHz | | | |

Here, the conditions regarding the type of estimation method, whether or not the sensitizer 14 was attached to the sensor 10, the number of analysis points (that is, frequency positions) when the learning processing was performed, the type of the learning model 30D, and whether or not ensemble learning was performed were variously changed, and the accuracy rate of estimation of the moisture absorption amount under each condition was calculated. Here, the accuracy rate is a rate at which it could be determined that the water absorption amount was within the range of 100 to 200 ml when reflected wave spectra of 100 diapers in which 150 ml of water was absorbed (100 reflected wave spectra acquired while changing the orientation and position of the reader 20) were acquired, and when detection of the state of each diaper was conducted for each of the reflected wave spectra using the pre-trained learning model 30D.

In the peak pick method in Comparative Example 1-1, a calibration curve for regression analysis was created using as variables the intensity ratio and the water absorption amount at the peak frequency of the reflected wave spectrum serving as the training data, and estimation of the moisture absorption amount was attempted using the calibration curve. However, in this method, a resonance peak could not be detected in the reflected wave spectrum of a diaper having water absorption of 100 ml or more, and a calibration curve for regression analysis could not be created.

In the single regression analysis in Comparative Example 1-2, a calibration curve for regression analysis was created using as variables the intensity ratio and the water absorption amount at 9.8 GHzGHz (here, the frequency corresponds to a frequency near the resonance frequency of the sensor 10) of the reflected wave spectrum serving as the training data, and estimation of the moisture absorption amount was attempted using the calibration curve. However, with this method, only a 14% accuracy rate was obtained.

In the multiple regression analysis in Example 1-1, a calibration curve for regression analysis was created setting the number of analysis points of the reflected wave spectrum serving as the training data to three points (intensity ratios at 9.0, 9.8 GHz, and 10.5 GHz) and using the water absorption amount as a variable, and estimation of the moisture absorption amount was attempted using the calibration curve. In this method, a 60% accuracy rate was obtained.

In the machine learning method in Example 1-2, a learning model was generated by means of the SVM using training data with a slightly wet state of a diaper having water absorption of 100 ml or 200 ml as a label, and training data with a heavily wet state of a diaper having water absorption of 300 ml or 400 ml as a label. At this time, as analysis points, the intensity ratios at 9.0 GHz, 9.8 GHz, and 10.5 GHz of the reflected wave spectrum were taken. Then, when the detection of the state of the diaper was conducted using the generated pre-trained learning model on the reflected wave spectra of the 100 diapers in which 150 ml of water was absorbed, the number of diapers that were identified as being in a slightly wet state (a state where the water absorption amount was within the range of 100 to 200 ml) was 72 diapers (accuracy rate: 72%).

In the machine learning method in Example 1-3, a similar operation to that in Example 1-2 was performed except that the number of analysis points was 150 points with each point set at every 10 MHz in the range of 9 GHz to 10.5 GHz. Then, when the detection of the state of the diaper was conducted using the generated pre-trained model on the reflected wave spectra of the 100 diapers in which 150 ml of water was absorbed, the number of diapers that were identified as being in a slightly wet state (a state where the water absorption amount was within the range of 100 to 200 ml) was 83 diapers (accuracy rate: 83%).

In the machine learning method in Example 1-4, a similar operation to that in Example 1-3 was performed except that the SVM was changed to the k-nearest neighbor. Then, when the detection of the state of the diaper was conducted using the generated pre-trained model on the reflected wave spectra of the 100 diapers in which 150 ml of water was absorbed, the number of diapers that were identified as being in a slightly wet state (a state where the water absorption amount was within the range of 100 to 200 ml) was 82 diapers (accuracy rate: 82%).

In the machine learning method in Example 1-5, a similar operation to that in Example 1-3 was performed except that a plurality of learning models were generated by means of the SVM, and that a pre-trained model was generated by means of ensemble learning thereof. Then, when the detection of the state of the diaper was conducted using the generated pre-trained model on the reflected wave spectra of the 100 diapers in which 150 ml of water was absorbed, the number of diapers that were identified as being in a slightly wet state (a state where the water absorption amount was within the range of 100 to 200 ml) was 92 diapers (accuracy rate: 92%).

In the multiple regression analysis in Example 1-6, similar learning processing and estimation processing to those in Example 1-2 were performed using the sensor 10 provided with the sensitizer 14 (here, a moisture absorbing material made of polyvinyl alcohol). As a result, the number of diapers that were identified as being in a slightly wet state (a state where the water absorption amount was within the range of 100 to 200 ml) was 67 diapers (accuracy rate: 67%).

In the machine learning method in Example 1-7, similar learning processing and estimation processing to those in Example 1-3 were performed using the sensor 10 provided with the sensitizer 14 (here, a moisture absorbing material made of polyvinyl alcohol). As a result, the number of diapers that were identified as being in a slightly wet state (a state where the water absorption amount was within the range of 100 to 200 ml) was 98 diapers (accuracy rate: 98%).

In the above manner, it has been found that, by estimating the moisture absorption amount using the learning model 30D generated by means of the multiple regression analysis or the machine learning method, it is possible to accurately estimate the moisture absorption amount as compared with the mode in which the moisture absorption amount is estimated in a conventional method such as the peak pick method.

### Example 2

In Example 2, the state detection system U according to the present disclosure is applied to estimation of the position of a paper cup.

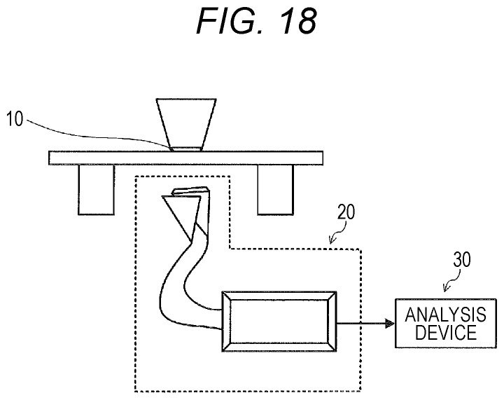

FIG. 18 is a diagram illustrating a configuration of Example 2. In Example 2, the sensor 10 was attached to the bottom of a paper cup, and the reflected wave spectrum of the reflected wave from the sensor 10 was acquired by means of the reader 20 disposed below the paper cup. Then, this example verified whether or not the situation when the paper cup was displaced to the side by 0.5 cm from the opposed position to the reader 20 could be estimated accurately.

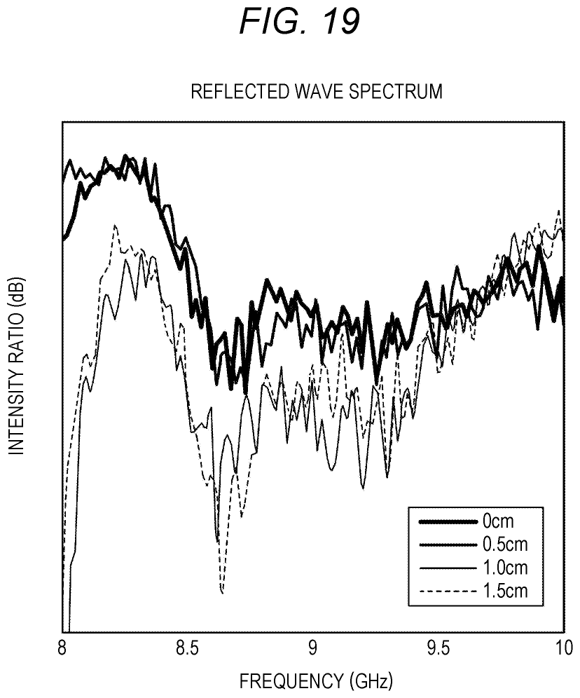

FIG. 19 is a diagram illustrating a representative reflected wave spectrum obtained for each cup position of the paper cup. FIG. 19 illustrates a reflected wave spectrum obtained at each position when the paper cup is displaced to the side by 0.0 cm, 0.5 cm, 1.0 cm, and 1.5 cm from the opposed position to the reader 20. In each learning processing on the learning model, the reflected wave spectrum information in each state in FIG. 19 was used.

Table 2 is a table illustrating various estimation methods used in Example 2 and evaluation results thereof.

TABLE 2

| | | Number of | | Ensemble | |
|---|---|---|---|---|---|
| Example No. | Estimation method | analysis points | Learning model | learning | Accuracy rate |
| Comparative | Peak pick | 1 | Single regression | — | Estimation |
| Example 2-1 | | | model | | impossible |
| Example 2-1 | Multiple regression | 3 | Multiple regression | — | 60% |
| | analysis | | model | | |
| Example 2-2 | Machine learning | 3 | SVM | — | 72% |
| Example 2-3 | Machine learning | 1 at every 10 MHz | SVM | — | 83% |
| Example 2-4 | Machine learning | 1 at every 10 MHz | SVM | ◯ | 92% |

Here, the conditions regarding the type of estimation method, whether or not the sensitizer 14 was attached to the sensor 10, the number of analysis points (that is, frequency positions) when the learning processing was performed, the type of the learning model 30D, and whether or not ensemble learning was performed were variously changed, and the accuracy rate of estimation of the cup position under each condition was calculated. Here, the accuracy rate is a rate at which it could be determined that the position of the paper cup was within the range of 0.5±0.1 cm when the paper cup was installed at the position of 0.5 cm, when 100 reflected wave spectra (100 reflected wave spectra acquired while changing the orientation and position of the reader 20) were acquired, and when estimation of the position of the paper cup was conducted for each of the reflected wave spectra using the pre-trained learning model 30D, using the pre-trained learning model 30D.

In the peak pick method in Comparative Example 2-1, creation of a calibration curve for regression analysis was attempted by picking up the peak frequency of the reflected wave spectrum serving as the training data and using as variables the intensity ratio and the side movement position at the frequency. However, a peak could not be detected in any of the spectra, and a calibration curve could not be created. In the peak pick method, the installation position of the paper cup could not be clarified.

In the multiple regression analysis in Example 2-1, multiple regression analysis was performed using, as variables, the intensity ratio and the side movement position at each of 8.0 GHz, 9.0 GHz, and 10.0 GHz taken as the analysis points of the reflected wave spectrum serving as the training data. Then, the paper cup to which the sensor 10 was attached was installed again at a position of 0.5 cm, the reflected wave spectrum was measured with n=100, and the position of the paper cup was estimated from the intensity ratios at the analysis points of the reflected wave spectrum. As a result, the number of cases where the position was identified as a position within the range of 0.5±0.1 cm was 60 cases (accuracy rate: 60%).

In the machine learning method in Example 2-2, a pre-trained model was generated by means of the SVM using training data of the intensity ratios at 8.0 GHz, 9.0 GHz, and 10.0 GHz with each of the positions of the paper cup as a label. Then, the paper cup to which the sensor was attached was installed again at a position of 0.5 cm, and the reflected wave spectrum was measured with n=100. The number of cases where the position of the paper cup was identified as a position of 0.5 cm from the intensity ratios at the analysis points of the reflected wave spectrum using the generated pre-trained model was 72 cases (accuracy rate: 72%).

In the machine learning method in Example 2-3, a similar operation to that in Example 2-2 was performed except that the number of analysis points was 200 points with each point set at every 10 MHz in the range of 8 to 10 GHz. Then, the paper cup to which the sensor was attached was installed again at a position of 0.5 cm, the reflected wave spectrum was measured with n=100, and the position of the paper cup was identified from the intensity ratios at the analysis points of the reflected wave spectrum using the generated pre-trained model. As a result, the number of cases where the position was identified as a position of 0.5 cm was 83 cases (accuracy rate: 83%).

In the machine learning method in Example 2-4, a similar operation to that in Example 2-3 was performed except that a plurality of learning models were generated by means of the SVM, and that a pre-trained model was generated by means of ensemble learning thereof. Then, the paper cup to which the sensor was attached was installed again at a position of 0.5 cm, the reflected wave spectrum was measured with n=100, and the position of the paper cup was identified from the intensity ratios at the analysis points of the reflected wave spectrum using the generated pre-trained model. As a result, the number of cases where the position was identified as a position of 0.5 cm was 92 cases (accuracy rate: 92%).

In the above manner, it has been found that, by estimating the cup position using the learning model 30D generated by means of the multiple regression analysis or the machine learning method, it is possible to accurately estimate the cup position as compared with the mode in which the cup position is estimated in a conventional method such as the peak pick method.

### Example 3

In Example 3, the state detection system U according to the present disclosure is applied to estimation of the stretched state of a substrate.

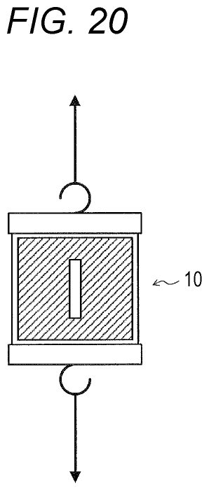

FIG. 20 is a diagram illustrating a configuration of Example 3. In Example 3, a sample made of a polyethylene terephthalate substrate to which the sensor 10 was attached was installed in a tensile strength tester, a reflected wave spectrum of a reflected wave from the sensor 10 when the substrate was stretched was detected, and estimation of the stretched state of the substrate was conducted.

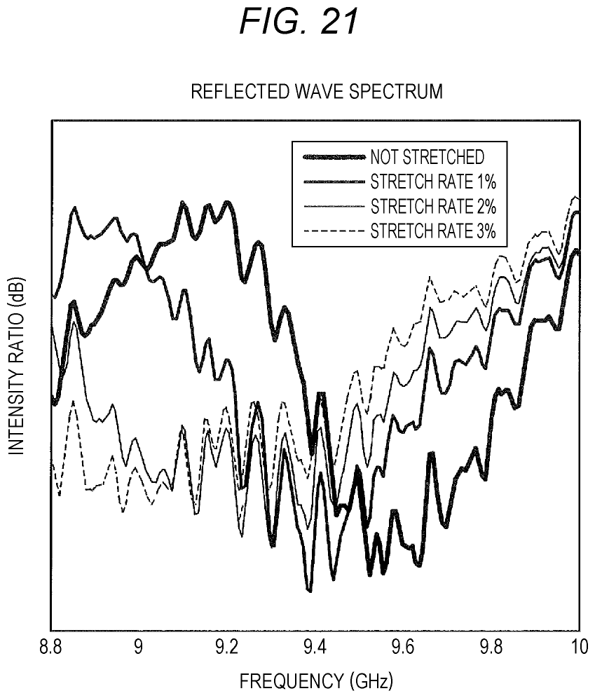

FIG. 21 is a diagram illustrating representative reflected wave spectra in respective states where the substrate is not stretched, 1% stretched, 2% stretched, and 3% stretched. Note that, as illustrated in FIG. 21, in a case where the sample is stretched by 3%, a resonance peak is not observed due to the breakage of the sensor 10. In each learning processing on the learning model to be described below, the reflected wave spectrum information in each state in FIG. 21 was used.

Table 3 is a table illustrating various estimation methods used in Example 3 and evaluation results thereof.

TABLE 3

| | Estimation | | Number of | Learning | Ensemble | Accuracy |
|---|---|---|---|---|---|---|
| Example No. | method | Sensitizer | analysis points | model | learning | rate |
| Comparative | Peak | Not | 1 | Single | — | Estimation |
| Example 3-1 | pick | provided | | regression | | impossible |
| | | | | model | | |
| Comparative | Single | Not | 1 | Single | — | 23% |
| Example 3-2 | regression | provided | | regression | | |
| | analysis | | | model | | |
| Example 3-1 | Multiple | Not | 3 | Multiple | — | 62% |
| | regression | provided | | regression | | |
| | analysis | | | model | | |
| Example 3-2 | Machine | Not | 3 | SVM | — | 75% |
| | learning | provided | | | | |
| Example 3-3 | Machine | Not | 1 at every | SVM | — | 82% |
| | learning | provided | 10 MHz | | | |
| Example 3-4 | Machine | Not | 1 at every | k-nearest | — | 81% |
| | learning | provided | 10 MHz | neighbor | | |
| Example 3-5 | Machine | Not | 1 at every | SVM | ◯ | 94% |
| | learning | provided | 10 MHz | | | |
| Example 3-6 | Multiple | Provided | 3 | Multiple | — | 69% |
| | regression | | | regression | | |
| | analysis | | | model | | |
| Example 3-7 | Machine | Provided | 1 at every | SVM | — | 96% |
| | learning | | 10 MHz | | | |

Here, the conditions regarding the type of estimation method, whether or not the sensitizer 14 was attached to the sensor 10, the number of analysis points (that is, frequency positions) when the learning processing was performed, the type of the learning model, and whether or not ensemble learning was performed were variously changed, and the accuracy rate of estimation of the stretch rate under each condition was calculated. Here, the accuracy rate is a rate at which it was determined that the stretch rate was 1.5% to 2.5% when reflected wave spectra of 100 samples that were stretched by 2% (100 reflected wave spectra acquired while changing the orientation and position of the reader 20) were acquired, and when detection of the state of each sample was conducted for each of the reflected wave spectra using the pre-trained learning model.

In the peak pick method in Comparative Example 3-1, a calibration curve for regression analysis was created using as variables the intensity ratio and the stretch rate (%) at the peak frequency of the reflected wave spectrum serving as the training data, and estimation of the stretch rate was attempted using the calibration curve. However, in this method, a resonance peak could not be detected at the time of 2% stretch and 3% stretch, and a calibration curve for regression analysis could not be created.

In the single regression analysis in Comparative Example 3-2, a reflected wave spectrum of a sample with each stretch rate (%) was measured, and regression analysis was performed using the intensity ratio and the stretch rate (%) at 9.4 GHz as variables to create a calibration curve of the stretch rate and the intensity ratio. Subsequently, 100 samples obtained by stretching the samples by 2% with a tensile strength tester were separately prepared, and the reflected wave spectra were measured. Then, when the stretch rate (%) was read from the intensity ratio at 9.4 GHz of each reflected wave spectrum with reference to the calibration curve described above, the number of samples that were detected as those having a stretch rate of about 2% (1.5% to 2.5%) was only 23 samples (accuracy rate: 23%).

In the multiple regression analysis in Example 3-1, using the reflected wave spectra of 100 samples stretched by 1%, 100 samples stretched by 2%, and 100 samples stretched by 3%, multiple regression analysis was performed using, as variables, the intensity ratio and the stretch rate (%) at each of 9.0, 9.4, and 9.8 GHzGHz taken as analysis points of the reflected wave spectrum of each stretch rate (%) sample. Subsequently, 100 samples in FIG. 51 obtained by stretching the samples by 2% with a tensile strength tester were separately prepared, and the reflected wave spectra were measured. When the stretch rate was confirmed from each intensity ratio at each analysis point, the number of samples that were detected as those having a stretch rate of about 2% (1.5% to 2.5%) was only 62 samples (accuracy rate: 62%).

In the machine learning method in Example 3-2, using the reflected wave spectra of 100 samples stretched by 1%, 100 samples stretched by 2%, and 100 samples stretched by 3%, a pre-trained model was generated by means of the SVM using as training data the intensity ratio at each of 9.0, 9.4, and 9.8 GHzGHz taken as analysis points of the reflected wave spectrum of each stretch rate (%) sample with each stretch rate (%) as a label. Subsequently, 100 samples obtained by stretching the samples by 2% with a tensile strength tester were separately prepared, and the reflected wave spectra were measured. When it was confirmed using the generated learning model whether or not the stretch rate was identified as 2% from each intensity ratio at each analysis point, 75 samples out of 100 samples were detected as those having a stretch rate of 2% (accuracy rate: 75%).

In the machine learning method in Example 3-3, a similar operation to that in Example 3-2 was performed except that the number of analysis points at which the intensity ratio was taken was 120 points with each point set at every 10 MHz in the range of 8.8 to 10.0 GHz. Then, when 100 samples obtained by stretching the samples by 2% with a tensile strength tester were separately prepared, and it was confirmed using the generated learning model whether or not the stretch rate was identified as 2% from the intensity ratio at each analysis point of each of the reflected wave spectra, 82 samples out of 100 samples were detected as those having a stretch rate of 2% (accuracy rate: 82%).

In the machine learning method in Example 3-4, a similar operation to that in Example 3-3 was performed except that the SVM was changed to the k-nearest neighbor. Then, when the stretch rate of each sample was identified using the generated learning model for the reflected wave spectrum of each sample having a stretch rate of 2% generated separately, 81 samples out of 100 samples were detected as those having a stretch rate of 2% (accuracy rate: 81%).

In the machine learning method in Example 3-5, a similar operation to that in Example 3-4 was performed except that a plurality of learning models were generated by means of the SVM, and that a pre-trained model was generated by means of ensemble learning thereof. Then, when the stretch rate of each sample was identified using the generated learning model for the reflected wave spectrum of each sample having a stretch rate of 2% generated separately, 94 samples out of 100 samples were detected as those having a stretch rate of 2% (accuracy rate: 94%).

In the multiple regression analysis in Example 3-6, similar learning processing and estimation processing to those in Example 3-1 were performed using the sensor 10 provided with the sensitizer 14 (here, an ethylcellulose resin film disposed in the slot of the resonator 11 of the sensor 10). As a result, the number of samples detected as those having a stretch rate of 2% (1.5% to 2.5%) was 69 samples (accuracy rate: 69%). Note that the sensitizer 14 is a member in which fine cracks are generated and the dielectric constant changes when external stress is applied. The dielectric constant of the sensitizer 14 is, for example, about 2.1 before application of external stress, and changes to, for example, about 1.4 after application of external stress.

In the machine learning method in Example 3-7, similar learning processing and estimation processing to those in Example 3-3 were performed using the sensor 10 provided with the sensitizer 14 (here, an ethylcellulose resin film disposed in the slot of the resonator 11 of the sensor 10). As a result, the number of samples detected as those having a stretch rate of 2% (1.5% to 2.5%) was 96 samples (accuracy rate: 96%).

In the above manner, it has been found that, by estimating the degree of stretch of the substrate using the learning model 30D generated by means of the multiple regression analysis or the machine learning method, it is possible to accurately estimate the degree of stretch as compared with the mode in which the degree of stretch is estimated in a conventional method such as the peak pick method.

### Example 4

In Example 4, the state detection system U according to the present disclosure is applied to estimation of the ethylene gas concentration.

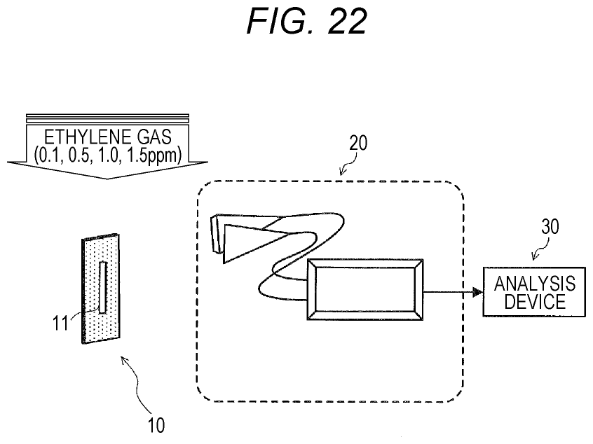

FIG. 22 is a diagram illustrating a configuration of Example 4. In Example 4, the sensor 10 has the sensor structure in FIG. 2, and the conductive material constituting the resonator 11 includes a material whose conductivity changes due to adhesion of ethylene. Here, a part of the conductive material constituting the resonator 11 includes a gas absorbing material made of carbon nanotubes. The sensor 10 is configured such that the reflected wave spectrum changes (here, the peak intensity of the resonance peak changes) in accordance with the adhesion amount of ethylene.

In Example 4, a reflected wave spectrum was measured while spraying ethylene gas at each concentration (0.1 ppm, 0.5 ppm, 1.0 ppm, and 1.5 ppm) on the sensor 10, and training data was acquired (not illustrated).

Table 4 is a table illustrating various estimation methods used in Example 4 and evaluation results thereof.

TABLE 4

| | Estimation | | Number of | Learning | Ensemble | External | Accuracy |
|---|---|---|---|---|---|---|---|
| Example No. | method | Sensitizer | analysis points | model | learning | stimulus | rate % |
| Comparative | Peak | Not | 1 | Single | Not | Not | Estimation |
| Example 4-1 | pick | provided | | regression | performed | applied | impossible |
| | | | | model | | | |
| Comparative | Single | Not | 1 | Single | Not | Not | 7% |
| Example 4-2 | regression | provided | | regression | performed | applied | |
| | analysis | | | model | | | |
| Example 4-1 | Multiple | Not | 3 | Multiple | Not | Not | 42% |
| | regression | provided | | regression | performed | applied | |
| | analysis | | | model | | | |
| Example 4-2 | Multiple | Not | 3 | Multiple | Not | Light | 52% |
| | regression | provided | | regression | performed | stimulus | |
| | analysis | | | model | | | |
| Example 4-3 | Multiple | Provided | 3 | Multiple | Not | Not | 57% |
| | regression | | | regression | performed | applied | |
| | analysis | | | model | | | |
| Example 4-4 | Multiple | Provided | 3 | Multiple | Not | Light | 65% |
| | regression | | | regression | performed | stimulus | |
| | analysis | | | model | | | |
| Example 4-5 | Machine | Provided | 3 | SVM | Not | Not | 71% |
| | learning | | | | performed | applied | |
| Example 4-6 | Machine | Provided | 3 | SVM | Not | Light | 83% |
| | learning | | | | performed | stimulus | |
| Example 4-7 | Machine | Provided | 1 at every | SVM | Not | Light | 92% |
| | learning | | 10 MHz | | performed | stimulus | |
| Example 4-8 | Machine | Provided | 1 at every | SVM | Performed | Light | 95% |
| | learning | | 10 MHz | | | stimulus | |

Here, the conditions regarding the type of estimation method, whether or not the sensitizer 14 was attached to the sensor 10, the number of analysis points (that is, frequency positions) when the learning processing was performed, the type of the learning model 30D, whether or not ensemble learning was performed, and whether or not an external stimulus was applied were variously changed, and the accuracy rate of estimation of the gas concentration under each condition was calculated. Here, the accuracy rate is a rate at which it could be determined that the ethylene gas concentration was within the range of 0.5 to 1.0 ppm when a reflected wave spectrum was measured 100 times while spraying the ethylene gas of 0.8 ppm on the sensor 10.

Note that, in Example 4, in the modes in which the sensitizer 14 is used (Examples 4-3 to 4-8), a copper complex is provided as a sensitizer to the carbon nanotube layer constituting the conductive member of the resonator 11. The conductivity of the carbon nanotube layer greatly changes when ethylene gas adheres to the copper complex portion. That is, this increases the resonance current flowing through the resonator 11 and emphasizes the change in the resonance peak caused by the change in the gas concentration of the ethylene gas.

Also, in Example 4, in the modes in which an external stimulus was given to the sensor 10 (Example 4-2, Example 4-4, and Example 4-6 to Example 4-8), the reader 20 irradiated the sensor 10 with light. By irradiating the gas absorbing material made of the carbon nanotube layer (and the copper complex) with light at the time of acquiring the reflected wave spectrum of the sensor 10, the gas absorbing amount in the carbon nanotube layer (and the copper complex) can be increased. That is, as a result, at the time of acquiring the reflected wave spectrum of the sensor 10, the amount of change in conductivity of the carbon nanotube layer due to gas absorption was increased.

In the peak pick method in Comparative Example 4-1, creation of a calibration curve for regression analysis was attempted using as variables the intensity ratio and the gas concentration at the peak frequency of the reflected electromagnetic wave spectrum of the sensor 10 at each ethylene gas concentration. However, a peak could not be detected in the reflected electromagnetic wave spectrum at a concentration of 1.0 ppm or less, and a calibration curve could not be created. In the peak pick method, a state in which the ethylene gas concentration was 0.5 to 1.0 ppm could not be identified.

In the single regression analysis in Comparative Example 4-2, the measurement of the reflected electromagnetic wave spectrum of the sensor 10 was performed 100 times while spraying the gas containing ethylene at each concentration (0.1 ppm, 0.5 ppm, 1.0 ppm, and 1.5 ppm), and a calibration curve for regression analysis was created using the intensity ratio and the gas concentration at 8.0 GHz as variables. Subsequently, the reflected electromagnetic wave spectrum was measured 100 times while spraying 0.8 ppm of ethylene gas on the sensor 10. The number of times where it could be determined that the ethylene gas concentration was within the range of 0.5 to 1.0 ppm from the intensity ratio at 8.0 GHz of the reflected electromagnetic wave spectrum with reference to the aforementioned calibration curve was only 7 times out of 100 times (accuracy rate: 7%).

In the multiple regression analysis in Example 4-1, the number of analysis points of the reflected wave spectrum serving as the training data was changed to 3 points (intensity ratios at 7.3 GHz, 8.0 GHz, and 8.7 GHz) from that of the single regression analysis in Comparative Example 4-2. Subsequently, the measurement of the reflected electromagnetic wave spectrum of the sensor 10 was performed 100 times while spraying 0.8 ppm ethylene gas, and detection of the ethylene gas concentration was conducted from the three analysis points of the spectrum by means of the multiple regression analysis. Then, the number of times where it could be determined that the ethylene gas concentration was within the range of 0.5 to 1.0 ppm was 42 times out of 100 times (accuracy rate: 42%).

In the machine learning method in Example 4-2, a similar operation to that in Example 4-1 was performed except that the measurement of the reflected electromagnetic wave spectrum of the sensor 10 was performed while emitting 100,000 lx of light as an external stimulus. The measurement of the reflected electromagnetic wave spectrum of the sensor 10 was performed 100 times while emitting 100,000 lx of light and spraying 0.8 ppm ethylene gas, and detection of the ethylene gas concentration was conducted from the three analysis points of the spectrum by means of the multiple regression analysis. Then, the number of times where it could be determined that the ethylene gas concentration was within the range of 0.5 to 1.0 ppm was 52 times out of 100 times (accuracy rate: 52%).

In the machine learning method in Example 4-3, a similar operation to that in Example 4-2 was performed except that the sensitizer 14 (here, the carbon nanotube layer) was used. The measurement of the reflected electromagnetic wave spectrum of the sensor 10 was performed 100 times while spraying 0.8 ppm ethylene gas, and the number of times where it could be determined by means of the multiple regression analysis that the ethylene gas concentration was within the range of 0.5 to 1.0 ppm was 57 times out of 100 times (accuracy rate: 57%).

In the machine learning method in Example 4-4, a similar operation to that in Example 4-2 was performed except that the measurement of the reflected electromagnetic wave spectrum was performed while giving the sensor 10 a light stimulus. The number of times where it could be determined by means of the multiple regression analysis that the ethylene gas concentration was within the range of 0.5 to 1.0 ppm was 65 times out of 100 times (accuracy rate: 65%).

In the machine learning method in Example 4-5, for three analysis points (intensity ratios at 7.3 GHz, 8.0 GHz, and 8.7 GHz) of each of 100 reflected electromagnetic wave spectra of the sensor 10 at each gas concentration, the learning processing was performed on the learning model 30D by means of the SVM using the training data with a spectrum having a gas concentration of 0.1 ppm as the label of the immature state, the training data with a spectrum having a gas concentration of 0.5 or 1.0 ppm as the label of the state of the appropriate harvest time, and the training data with a spectrum having a gas concentration of 1.5 ppm as the label of the overmature state. Subsequently, the measurement of the reflected electromagnetic wave spectrum of the sensor 10 was performed 100 times while spraying 0.8 ppm ethylene gas, and detection of the state was conducted for each reflected electromagnetic wave spectrum using the generated learning model 30D. Then, the number of times where it could be determined that the state showed the appropriate harvest time (gas concentration: 0.5 to 1.0 ppm) was 71 times (accuracy rate: 71%).

In the machine learning method in Example 4-6, a similar operation to that in Example 4-5 was performed except that the measurement of the reflected electromagnetic wave spectrum of the sensor 10 was performed while emitting 100,000 lx of light as an external stimulus, and learning processing was performed on the learning model 30D. Subsequently, the measurement of the reflected electromagnetic wave spectrum of the sensor 10 was performed 100 times while emitting 100,000 lx of light as an external stimulus and spraying 0.8 ppm ethylene gas, and detection of the state was conducted for each reflected electromagnetic wave spectrum using the generated learning model 30D. Then, the number of times where it could be determined that the gas concentration was 0.5 to 1.0 ppm was 83 times (accuracy rate: 83%).

In the machine learning method in Example 4-7, a similar operation to that in Example 4-6 was performed except that the number of analysis points was 301 points with each point set at every 10 MHz in the range of 7 to 10 GHz, and learning processing was performed on the learning model 30D. The measurement of the reflected electromagnetic wave spectrum of the sensor 10 was performed 100 times while emitting 100,000 lx of light as an external stimulus and spraying 0.8 ppm ethylene gas, and detection of the state was conducted for each reflected electromagnetic wave spectrum using the generated learning model 30D. Then, the number of times where it could be determined that the state showed the appropriate harvest time (gas concentration: 0.5 to 1.0 ppm) was 92 times (accuracy rate: 92%).

In the machine learning method in Example 4-8, a similar operation to that in Example 4-7 was performed except that a plurality of learning models 30D were generated by means of the SVM, and that learning processing was performed on the learning model 30D by means of ensemble learning thereof. The measurement of the reflected electromagnetic wave spectrum of the sensor 10 was performed 100 times while emitting 100,000 lx of light as an external stimulus and spraying 0.8 ppm ethylene gas, and detection of the state was conducted for each reflected electromagnetic wave spectrum using the generated learning model 30D. Then, the number of times where it could be determined that the state showed the appropriate harvest time (gas concentration: 0.5 to 1.0 ppm) was 95 times (accuracy rate: 95%).

In the above manner, it has been found that, by estimating the gas concentration using the learning model 30D generated by means of the multiple regression analysis or the machine learning method, it is possible to accurately estimate the cup position as compared with the mode in which the gas concentration is estimated in a conventional method such as the peak pick method.

[Effects]

As described above, with the state detection system U according to the present embodiment, even in a case where the resonance peak does not clearly appear in a reflected wave spectrum due to the influence of noise, it is possible to detect a state change of a detection target with high accuracy.

In particular, in a case where a model optimized by machine learning is used as the learning model 30D, robustness is further improved against a change in the frequency spectrum due to noise or an environmental change at the time of use, and the state change of the detection target can be detected accurately.

Also, by introducing the sensitizer 14 into the sensor 10 and giving an external stimulus in combination, the state change of the detection target can be detected with higher accuracy.

Further, by causing the sensor 10 to have a structure of including a resonator in which the absorption peak appears clearly at the time of resonance, the reflected wave spectrum of the sensor 10 can be a reflected wave spectrum in which a change accompanying the state change of the detection target easily appears. This makes it possible to detect the state change of the detection target with high accuracy.

Although specific examples of the present invention have been described in detail above, these are illustrative only, and do not limit the scope of the claims. The technology described in the claims includes various modifications and changes of the specific examples illustrated above.

The entire disclosure of the specification, drawings, and abstract included in Japanese Patent Application No. 2020 077776 filed on Apr. 24, 2020 is incorporated herein by reference.

### INDUSTRIAL APPLICABILITY

With a state detection system according to the present disclosure, it is possible to detect a state change of an object or an environmental change around an object with high accuracy.

### REFERENCE SIGNS LIST

U State detection system
10 Sensor
11, 111 Resonator
11B, 111B Substrate
12 Isolation layer
13, 113 Electromagnetic wave reflecting material
14 Sensitizer
20 Reader
21 Transmission unit
22 Reception unit
23 Control unit
30 Analysis device
31 Learning unit
32 Identification unit
30D Learning model

1. A state detection system comprising:
a sensor that includes an electromagnetic wave reflecting material and a resonator disposed adjacent to or integrally with the electromagnetic wave reflecting material, and that detects a state change of a surrounding object or surrounding environment as a change in its own electromagnetic wave reflection characteristic;
a reader that transmits an electromagnetic wave to the sensor and receives a reflected wave of the electromagnetic wave, and that acquires reflected wave spectrum information of the sensor; and
a hardware processor that estimates a current state of a detection target of the sensor by applying information regarding reflected wave intensities at a plurality of frequency positions of the reflected wave spectrum to a learning model generated in advance on a basis of training data of a reflected wave spectrum for each state of the sensor.

2. The state detection system according to claim 1, wherein
the plurality of frequency positions are frequency positions at every bandwidth of at least 500 MHz within a frequency band in which the reflected wave spectrum information is acquired.

3. The state detection system according to claim 1, wherein
the detection target of the sensor is any of a position of a surrounding object around the sensor, a form of a surrounding object around the sensor, moisture content of a surrounding object around the sensor, humidity of a surrounding environment around the sensor, a temperature of the surrounding environment around the sensor, a gas concentration of the surrounding environment around the sensor, light illuminance of the surrounding environment around the sensor, pH of the surrounding environment around the sensor, a magnetic intensity of the surrounding environment around the sensor, and a degree of oxidation of a surrounding object around the sensor.

4. The state detection system according to claim 1, wherein
the sensor includes a sensitizer that has sensitivity to the state change of the detection target and that changes the electromagnetic wave reflection characteristic of the sensor in accordance with the state change of the detection target.

5. The state detection system according to claim 1, wherein
the reader collects the reflected wave spectrum information while applying an external stimulus different, in nature, from the state change of the detection target to the sensor.

6. The state detection system according to claim 5, wherein
the external stimulus is light, heat, or an ultrasonic wave.

7. The state detection system according to claim 1, wherein
the training data is data of a reflected wave spectrum for each state of the sensor obtained by actual measurement or simulation.

8. The state detection system according to claim 1, wherein
a parameter of the learning model is optimized by training data including information regarding reflected wave intensities at the plurality of frequency positions of a reflected wave spectrum for each state of the sensor for which a state change amount of the detection target is set as a true value.

9. The state detection system according to claim 1, wherein
the learning model is a model optimized by machine learning.

10. The state detection system according to claim 9, wherein
the learning model is any of SVM, k-nearest neighbor, logistic regression, Lasso regression, ridge regression, elastic net regression, support vector regression, and a decision tree.

11. The state detection system according to claim 9, wherein
the learning model is trained by means of ensemble learning using at least one of SVM, k-nearest neighbor, logistic regression, Lasso regression, ridge regression, elastic net regression, support vector regression, and a decision tree.

12. The state detection system according to claim 9, wherein
a hyperparameter of the learning model is optimized by grid search.

13. The state detection system according to claim 1, wherein
the learning model is a model optimized by multiple regression analysis.

14. The state detection system according to claim 1, wherein
the sensor has a structure in which the resonator and the electromagnetic wave reflecting material are disposed to be opposed with an isolation layer interposed therebetween.

15. The state detection system according to claim 1, wherein
the sensor has a structure in which the resonator of a slot type is disposed in the electromagnetic wave reflecting material.

16. The state detection system according to claim 2, wherein
the detection target of the sensor is any of a position of a surrounding object around the sensor, a form of a surrounding object around the sensor, moisture content of a surrounding object around the sensor, humidity of a surrounding environment around the sensor, a temperature of the surrounding environment around the sensor, a gas concentration of the surrounding environment around the sensor, light illuminance of the surrounding environment around the sensor, pH of the surrounding environment around the sensor, a magnetic intensity of the surrounding environment around the sensor, and a degree of oxidation of a surrounding object around the sensor.

17. The state detection system according to claim 2, wherein
the sensor includes a sensitizer that has sensitivity to the state change of the detection target and that changes the electromagnetic wave reflection characteristic of the sensor in accordance with the state change of the detection target.

18. The state detection system according to claim 2, wherein
the reader collects the reflected wave spectrum information while applying an external stimulus different, in nature, from the state change of the detection target to the sensor.

19. The state detection system according to claim 2, wherein
the training data is data of a reflected wave spectrum for each state of the sensor obtained by actual measurement or simulation.

20. The state detection system according to claim 2, wherein
a parameter of the learning model is optimized by training data including information regarding reflected wave intensities at the plurality of frequency positions of a reflected wave spectrum for each state of the sensor for which a state change amount of the detection target is set as a true value.
